(19) United States
(12) Patent Application Publication
(10) Pub. No.: US 2013/0293585 A1
(43) Pub. Date: Nov. 7, 2013

(54) MOBILE TERMINAL AND CONTROL METHOD FOR MOBILE TERMINAL

(71) Applicant: Tomohiro Sudou, Yokohama-shi, Kanagawa (JP)

(72) Inventor: Tomohiro Sudou, Yokohama-shi, Kanagawa (JP)

(73) Assignee: KYOCERA CORPORATION, Kyoto (JP)

(21) Appl. No.: 13/980,292

(22) PCT Filed: Jan. 18, 2012
(86) PCT No.: PCT/JP2012/000272

§ 371 Date: Jul. 17, 2013

(30) Foreign Application Priority Data
Jan. 18, 2011 (JP) 2011-008109

(51) Int. Cl. G06T 19/00

(52) U.S. Cl. CPC G06T 19/006
USPC 345/633

(57) ABSTRACT

Display is switched between overlapping AR objects by a mobile terminal (10) including a touch sensor (103) that detects input, an imaging unit (106) that acquires an image, a display unit (102) that displays the image, and a control unit (110) that controls the display unit (102) to display virtual information included in the image by overlaying the virtual information on the image and that layers the virtual information and switches a display layer of the virtual information in accordance with the input.

### CROSS-REFERENCE TO RELATED APPLICATION

This application claims priority to and the benefit of Japanese

Patent Application No. 2011-8109 filed Jan. 18, 2011, the entire contents of which are incorporated herein by reference.

### FIELD

The present invention relates to a mobile terminal and to a control method for the mobile terminal, and in particular relates to a mobile terminal supporting AR technology for displaying virtual information overlaid on an actual image and to a control method for the mobile terminal.

### BACKGROUND

Technology referred to as Augmented Reality (AR) exists for combining a virtual image with a real environment and displaying the image. With AR technology, when a virtual information marker (AR marker) such as a barcode is included in an image photographed by a camera, virtual information (AR object) corresponding to the virtual information marker is displayed on the image. This places a user under the illusion that the AR object actually exists in the space captured by the camera. Furthermore, by displaying text as an AR object on an image, the user can, for example, confirm details on a store or the like included in the camera image.

In addition to being acquired from an AR marker, such as a barcode, included in an image, an AR object can be acquired from an external server using position information on the mobile terminal. For example, with the method in Patent Literature 1, air tags associated with position information are stored on a server. When an AR application on a mobile terminal is launched, the mobile terminal acquires the current position information by GPS and transmits the current position information to the server. The server acquires any air tags near the received position information and transmits the air tags to the mobile terminal. Upon acquiring the air tags, the mobile terminal displays the air tags overlaid on the image photographed by the camera.

### CITATION LIST

### Patent Literature

PTL 1: JP3700021B2

### SUMMARY

With related technology, AR objects are displayed in order of distance starting with the AR object closest to the terminal, thus leading to the problem of an AR object located in the background being hidden behind an AR object positioned at the front and thus not displayed.

The present invention conceived in light of these circumstances is to provide a mobile terminal that can switch between display of overlapping AR objects.

In order to achieve the above object, a mobile terminal according to a first aspect of the invention includes: a touch sensor configured to detect input; an imaging unit configured to acquire an image; a display unit configured to display the image; and a control unit configured to control the display unit to display virtual information included in the image by overlaying the virtual information on the image and configured to layer the virtual information and switch a display layer of the virtual information in accordance with the input.

A second aspect of the invention further includes a position information acquisition unit configured to acquire position information, wherein the control unit displays the virtual information by overlaying the virtual information on the image based on the position information.

In a third aspect of the invention, the control unit displays the virtual information associated with an object included in the image by overlaying the virtual information on the image.

A fourth aspect of the invention further includes a load detection unit configured to detect a pressure load of the input, such that the control unit switches the display layer of the virtual information in accordance with the pressure load.

In a fifth aspect of the invention, the control unit switches the display layer of the virtual information when the input is detected at a position where pieces of the virtual information are in overlap.

In a sixth aspect of the invention, the control unit only switches the display layer related to virtual information displayed at a position of the input.

In a seventh aspect of the invention, the control unit performs the layering in accordance with a type of the virtual information.

An eighth aspect of the invention further includes a tactile sensation providing unit configured to provide a tactile sensation to a touch face of the touch sensor, such that when virtual information at a back is hidden by virtual information at a front, the control unit controls the tactile sensation providing unit to provide a tactile sensation for the input upon the input being detected for the virtual information at the front.

While aspects of the present invention have been described above in terms of devices, the present invention may also be achieved by a method or a program substantially equivalent to the above devices, or by a storage medium having such a program recorded thereon. These aspects are also to be understood as included in the scope of the present invention.

For example, a ninth aspect of the present invention is a control method for a mobile terminal, the mobile terminal including a touch sensor configured to detect input, an imaging unit configured to acquire an image, and a display unit configured to display the image, the control method including the steps of: controlling the display unit to display virtual information included in the image by overlaying the virtual information on the image; layering the virtual information; and switching a display layer of the virtual information in accordance with the input.

The mobile terminal according to the present invention can switch between display of overlapping AR objects.

### BRIEF DESCRIPTION OF DRAWINGS

The present invention will be further described below with reference to the accompanying drawings, wherein:

FIG. 1 is a functional block diagram of a mobile terminal according to an embodiment of the present invention;

FIGS. 2A and 2B are a front view and a back view of the mobile terminal illustrated in FIG. 1;

FIGS. 3A and 3B illustrate an example of layering of AR objects;

FIG. 4 is an operational flowchart of the mobile terminal illustrated in FIG. 1;

FIG. 5 illustrates an example of displaying AR objects;

FIG. 6 is an operational flowchart of the mobile terminal illustrated in FIG. 1;

FIG. 7 illustrates an example of switching AR objects;

FIG. 8 illustrates an example of switching AR objects;

FIG. 9 illustrates an example of switching AR objects; and

FIGS. 10A and 10B illustrate an example of providing a tactile sensation to a hidden AR object.

### DESCRIPTION OF EMBODIMENTS

The following describes an embodiment of the present invention in detail with reference to the accompanying drawings. In the following embodiment, an example of a mobile terminal according to the present invention is assumed to be a mobile terminal such as a mobile phone or a PDA and to be provided with a touch panel. The mobile terminal according to the present invention, however, is not limited to such terminals and may, for example, be any of a variety of terminals including a game device, a digital camera, a portable audio player, a laptop computer, and a mini laptop computer.

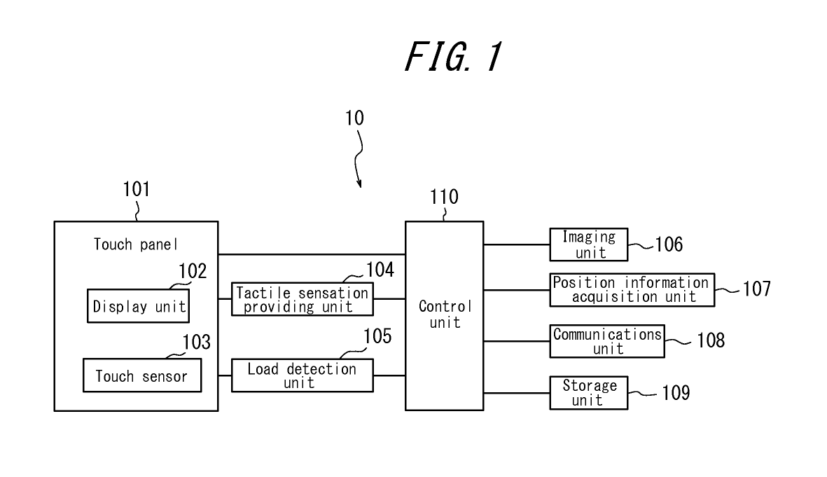

FIG. 1 is a functional block diagram schematically illustrating the internal configuration of a mobile terminal 10 according to an embodiment of the present invention. As illustrated in FIG. 1, the mobile terminal 10 is provided with a touch panel 101, a tactile sensation providing unit 104, a load detection unit 105, an imaging unit 106, a position information acquisition unit 107, a communications unit 108, a storage unit 109, and a control unit 110.

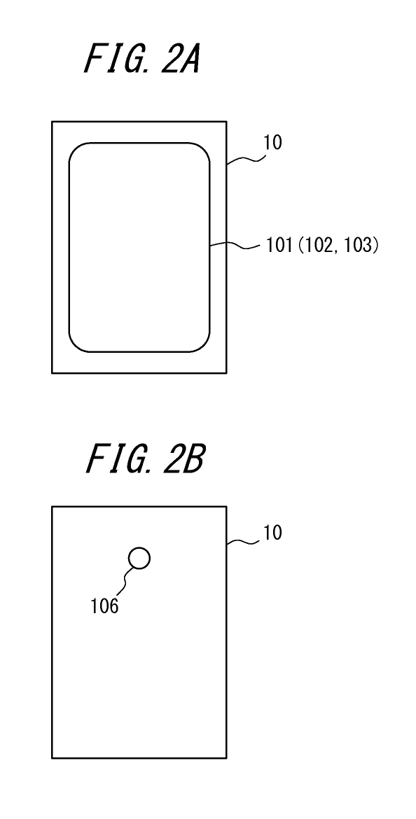

In the present embodiment, the touch panel 101 is provided with a display unit 102 and a touch sensor 103. The touch panel 101 is configured to have the touch sensor 103, which accepts user input, overlaid on the front of the display unit 102. FIG. 2A is a front view of the mobile terminal 10, and FIG. 2B is a back view of the mobile terminal 10. As illustrated in FIGS. 2A and 2B, the touch panel 101 (display unit 102 and touch sensor 103) is disposed on the front of the mobile terminal 10, and the imaging unit 106 is disposed on the back of the mobile terminal 10.

The display unit 102 of the touch panel 101 is, for example, configured using a liquid crystal display (LCD), an organic EL display, or the like. The display unit 102 displays images acquired by the imaging unit 106 and, when AR display is set ON, displays image with an AR object, which is virtual information, overlaid thereon. The touch sensor 103, which detects input on a touch face by a user's finger or the like, is disposed on the front of the display unit 102. This touch sensor 103 is of a well-known type, such as a resistive film type, a capacitive type, an optical type, or the like. Upon detecting input by the user's finger or the like, the touch sensor 103 provides the control unit 110 with information on the input position. Note that in order for the touch sensor 103 to detect input, it is not essential for the user's finger or the like to physically press the touch sensor 103. For example, if the touch sensor 103 is an optical type, the touch sensor 103 detects the position at which an infrared ray is blocked by a finger or the like and can therefore detect input even in the absence of a physical press.

The tactile sensation providing unit 104 transmits a vibration to the touch face of the touch sensor 103 and is, for example, configured using a piezoelectric element, an ultrasonic transducer, or the like. By vibrating, the tactile sensation providing unit 104 can provide a tactile sensation to a user's finger or the like pressing on the touch sensor 103. Furthermore, the tactile sensation providing unit 104 can be configured to vibrate the touch face of the touch sensor 103 indirectly by causing the mobile terminal 10 to vibrate via a vibration motor (eccentric motor).

The load detection unit 105 detects a pressure load on the touch face of the touch sensor 103 and is, for example, configured using a piezoelectric element, a strain gauge sensor, or the like. The load detection unit 105 provides the control unit 110 with the detected pressure load. Note that when, for example, the tactile sensation providing unit 104 and load detection unit 105 are both configured using a piezoelectric element, the tactile sensation providing unit 104 and the load detection unit 105 may be configured integrally by a common piezoelectric element. This is because a piezoelectric element has the property of generating an electric charge when pressure is applied and of deforming upon application of an electric charge.

The imaging unit 106 acquires a photographed image of the actual environment and is configured using, for example, an imaging lens, an imaging element, and the like. For AR processing, the image acquired by the imaging unit 106 is provided to the control unit 110. An image acquired by the imaging unit 106 when imaging has not been finalized (preview mode) is also provided to the control unit 110.

The position information acquisition unit 107 acquires the current position of the mobile terminal 10 (position information) and is, for example, configure using a Global Positioning System (GPS) device or the like. The position information acquisition unit 107 is also provided with an orientation sensor and can acquire the direction in which the mobile terminal 10 is facing (orientation information). The position information acquisition unit 107 provides the acquired position information and orientation information to the control unit 110.

The communications unit 108 communicates with an external AR server (not illustrated) and is, for example, configured using an interface device that supports wireless communication. The communications unit 108 transmits the position information and the orientation information acquired by the position information acquisition unit 107 to the AR server and receives data on an AR object corresponding to the transmitted information from the AR server. The AR server stores information on an AR object in association with position information, for example. Based on the position information and the orientation information of the mobile terminal 10, the AR server selects any AR objects included in the image acquired by the imaging unit 106 and transmits data on each selected AR object to the mobile terminal 10. Note that alternatively, from among AR objects transmitted in advance from the AR server based on the position information, the mobile terminal 10 may use the orientation information as a basis to select and display an AR object included in the image acquired by the imaging unit 106.

The storage unit 109 stores tactile sensation patterns provided by the tactile sensation providing unit 104 and also functions as a work memory and the like. The tactile sensation patterns referred to here are specified by factors such as the type of vibration (frequency, phase, vibration interval, number of vibrations, and the like) and the intensity of vibration (amplitude and the like). The storage unit 109 can store images acquired by the imaging unit 106.

The control unit 110 controls and manages the entire mobile terminal 10, starting with the functional units thereof, and is configured using a suitable processor such as a CPU. In particular, the control unit 110 causes the display unit 102 to display the acquired AR object overlaid on the image.

As for acquisition of the AR object, the control unit 110 can detect a virtual information marker (an object with which virtual information is associated; hereinafter referred to as an AR marker) in the image acquired by the imaging unit 106 and acquire an AR object corresponding to the AR marker. The control unit 110 can also transmit the position information and the orientation information acquired by the position information acquisition unit 107 to the AR server via the communications unit 108 and acquire information on any AR objects included in the image from the AR server. Note that the control unit 110 may instead acquire an AR object by reading data for an AR object stored in an external storage medium.

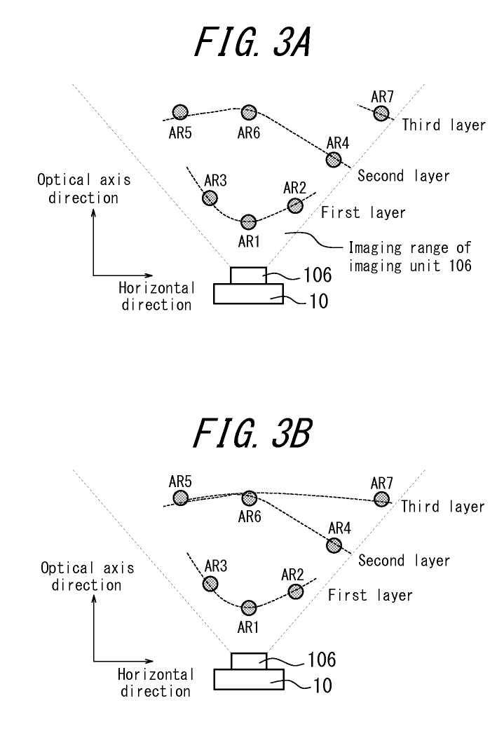

Upon acquiring the AR object in an image by detection of an AR marker, communication with the AR server, or the like, the control unit 110 layers the AR objects by analyzing the position and size of each AR object. FIGS. 3A and 3B illustrate an example of layering of AR objects. It is assumed that a plurality of AR objects (AR1 to AR7) are included in the image acquired by the imaging unit 106. In this case, based on the position and size of each AR object, the control unit 110 detects that AR2 overlaps with AR4 and AR7, that AR1 overlaps with AR6, and that AR3 overlaps with AR5. Next, as illustrated in FIG. 3A, in the direction of the optical axis of the imaging unit 106, the control unit 110 places AR1 to AR3 in a first layer, AR4 to AR6 in a second layer, and AR7 in a third layer. By switching the AR object display layer in accordance with input to the touch sensor 103, the control unit 110 can cause the display unit 102 to display an AR object hidden behind another AR object. Note that as illustrated in FIG. 3B, the control unit 110 can set the third layer to include AR5 and AR6 in addition to AR7. In other words, the control unit 110 may cause the AR object located furthest back at a location with little overlap between AR objects to be displayed when a deeper layer is displayed. The control unit 110 can layer the AR objects not only based on the location and size of the AR object, but also based on the type of information of the AR object. For example, when a store name, store review, store word-of-mouth information, and the like are types of an AR object for a store, the control unit 110 may place the store name, store review, and store word-of-mouth information each in a separate layer.

Upon layering the AR objects, the control unit 110 sets a condition for switching the AR object display layer. As the condition for switching the AR object display layer, the control unit 110 can use the pressure load detected by the load detection unit 105. For example, the control unit 110 can set the condition for switching so that any AR objects in the first layer are displayed when a pressure load satisfying a first load standard (level one press) is detected, and any AR objects in the second layer are displayed when a pressure load satisfying a second load standard (level two press) is detected. As a condition for switching the AR object display layer, the control unit 110 can also use the position of input on the touch sensor 103 by a finger or the like. For example, the control unit 110 can set a condition for switching such that the AR object display layer is switched when input is provided at a position where AR objects overlap. Note that when switching the AR object display layer, the control unit 110 can control driving of the tactile sensation providing unit 104 so as to provide a tactile sensation for the input. As a condition for switching the AR object display layer, instead of the pressure load, the control unit 110 can use data output by the load detection unit 105 upon detection of the pressure load. The data output by the load detection unit 105 may be electric power.

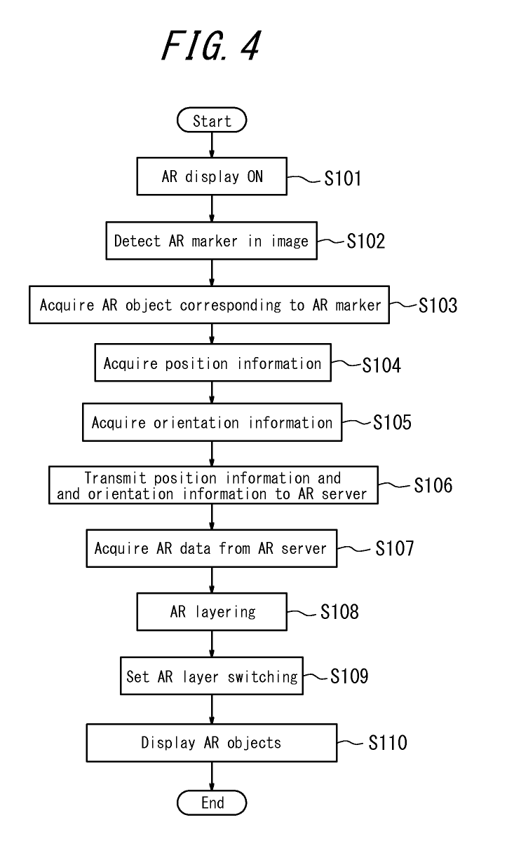

FIG. 4 is an operational flowchart of the mobile terminal 10. First, the AR display of the mobile terminal 10 turns on (step S101). Specifically, the AR display turns on in circumstances such as when an application that can display an AR object is launched or when AR object display is switched in a camera mode that can switch between display and non-display of an AR object. Next, the control unit 110 detects any AR markers in the image acquired by the imaging unit 106 (step S102) and acquires the AR object corresponding to the detected AR marker (step S103). The control unit 110 also acquires position information and orientation information from the position information acquisition unit 107 (steps S104, S105) and transmits the position information and the orientation information to the AR server via the communications unit 108 (step S106). At this point, the AR server selects any AR objects included in the image acquired by the imaging unit 106 of the mobile terminal 10 from the position information and the orientation information received from the mobile terminal 10 and transmits each selected AR object to the mobile terminal 10 as AR data. Note that as described above, the mobile terminal 10 can also transmit only the position information to the AR server and, from among AR objects transmitted by the AR server, display only an AR object selected based on the orientation information. Upon acquiring the AR data from the AR server (step S107), the control unit 110 layers any AR objects acquired from an AR marker and any AR objects acquired from the AR server (step S108). Next, the control unit 110 sets the condition for switching the AR object display layer (step S109) and causes the display unit 102 to display each AR object overlaid on the image acquired by the imaging unit 106 (step S110). Note that the processing in steps S102 to S103 and S104 to S107 in FIG. 4 may be performed in a different order. Furthermore, when no AR marker is detected in the image, the processing in steps S102 and S103 need not be performed.

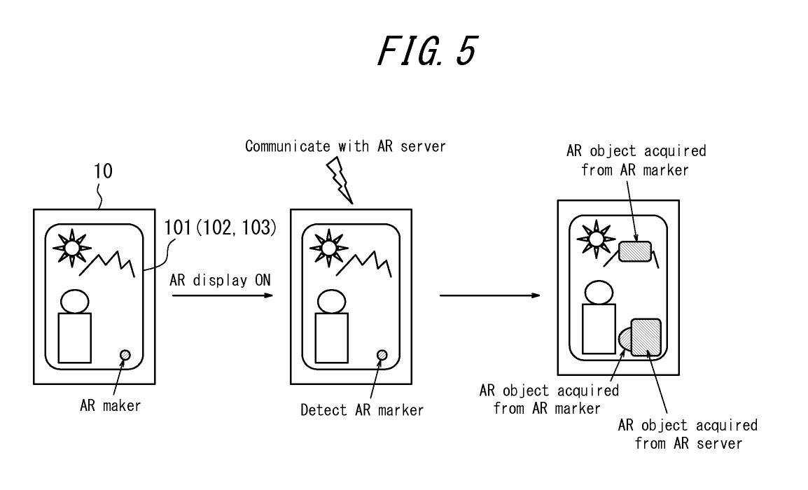

FIG. 5 illustrates an example of displaying AR objects. When the AR display of the mobile terminal 10 turns on, the control unit 110 acquires the AR object corresponding to the AR marker in the image and acquires AR objects from the AR server. Once AR objects are acquired by detection of the AR marker and communication with the AR server, the control unit 110 layers the AR objects, sets the condition for switching the display layer, and causes the display unit 102 to display the AR objects.

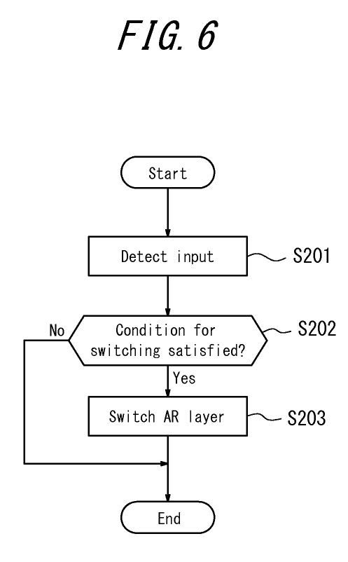

FIG. 6 is a flowchart of processing to switch the AR object display layer. Upon detecting input to the touch panel 101 based on a signal from the touch sensor 103 (step S201), the control unit 110 determines whether the input satisfies the condition for switching the display layer (step S202). If the input satisfies the condition for switching the display layer (step S202: Yes), the control unit 110 switches the AR object display layer (step S203).

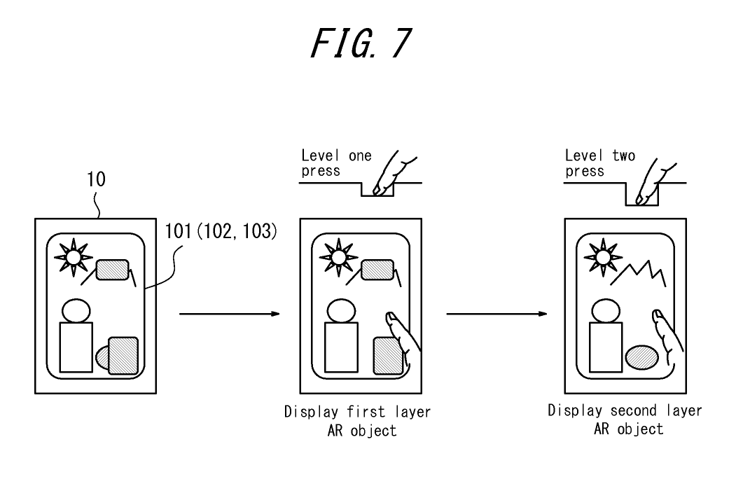

FIGS. 7 through 9 illustrate an example of switching between layered AR objects. FIG. 7 is an example of switching when the control unit 110 uses pressure load as the condition for switching the display layer. In the example in FIG. 7, the control unit 110 displays AR objects in the first layer when a pressure load satisfying a first load standard (level one press) is detected and displays AR objects in the second layer when a pressure load satisfying a second load standard (level two press) is detected.

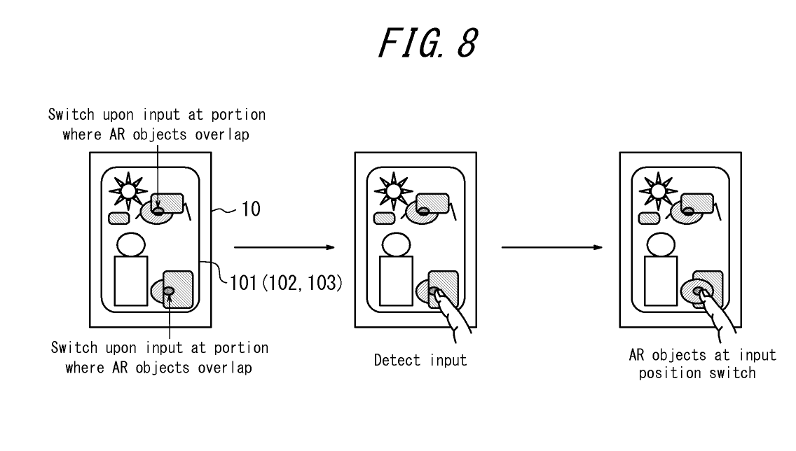

FIG. 8 is an example of switching when the control unit 110 uses the position of input to the touch sensor 103 as the condition for switching the display layer. In the example in FIG. 8, the control unit 110 switches the AR object display layer when input is provided at a position where AR objects overlap. In this case, the control unit 110 can switch only the display layer for the AR objects displayed at the input position. In other words, the control unit 110 can switch only the display layer for the AR objects displayed at the input position without switching the display layer for an AR object where input is not provided. The control unit 110 can also switch the AR object display layer when input is provided within a predetermined range from a position where AR objects overlap. Furthermore, the control unit 110 can use the pressure load and the input position together as conditions for switching the display layer. In this case, the control unit 110 switches the AR object display layer in accordance with the force of user input and the input position, and therefore the user can switch the AR object display layer by a more intuitive operation.

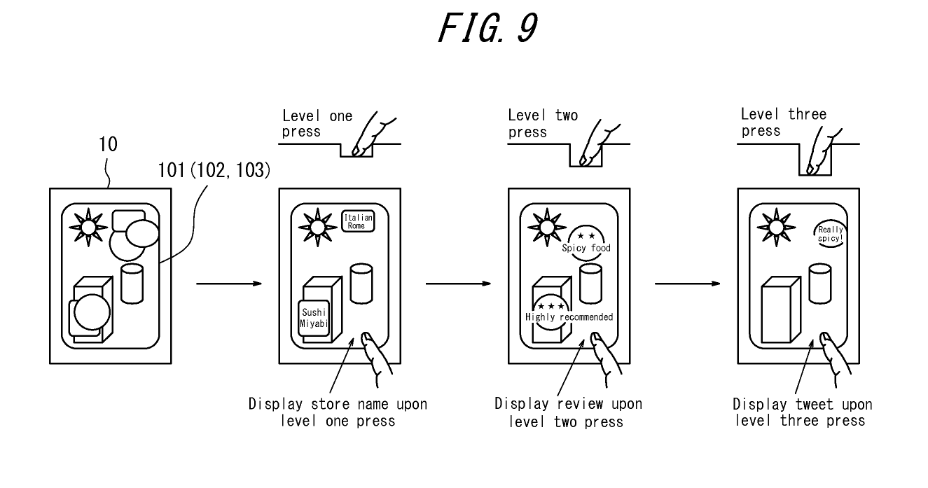

FIG. 9 is an example of switching the display layer when the control unit 110 layers the AR objects by type. In the example in FIG. 9, the control unit 110 sets the store name to be the first layer, the store review to be the second layer, and the store word-of-mouth information to be the third layer. The control unit 110 displays the store name, i.e. the first layer, when a pressure load satisfying a first load standard (level one press) is detected, displays the store review, i.e. the second layer, when a pressure load satisfying a second load standard (level two press) is detected, and displays the store word-of-mouth information, i.e. the third layer, when a pressure load satisfying a third load standard (level three press) is detected.

According to the present embodiment, the control unit 110 thus layers the AR objects (virtual information) and switches the AR object display layer in accordance with input to the touch sensor 103. In this way, the mobile terminal 10 according to the present embodiment can switch an AR object hidden at the back due to overlap so as to display the AR object at the front.

Based on the position information of the mobile terminal 10, the control unit 110 can also display an AR object overlaid on the image acquired by the imaging unit 106. In this way, the mobile terminal 10 according to the present embodiment can display an AR object included in an image acquired by the imaging unit 106.

The control unit 110 can also display an AR object (virtual information) associated with an object (AR marker) that is included in an image acquired by the imaging unit 106 by overlaying the AR object on the image. In this way, the mobile terminal 10 according to the present embodiment can display an AR object included in an image acquired by the imaging unit 106.

The control unit 110 can also switch the AR object display layer in accordance with the pressure load of a finger or the like. In this way, the mobile terminal 10 according to the present embodiment can switch the display layer in accordance with the force of user input, so that the user can switch display of the AR object by an intuitive operation.

The control unit 110 can also switch the AR object display layer when input is detected at a position where AR objects overlap. In this way, the mobile terminal 10 according to the present embodiment can switch the display layer in accordance with the position of user input, so that the user can switch display of the AR objects by a more intuitive operation.

The control unit 110 can also switch only the display layer for the AR object displayed at the input position. In this way, the mobile terminal 10 according to the present embodiment can switch the display layer of only an AR object chosen by the user, so that the user can switch display of the AR object by a more intuitive operation.

The control unit 110 can also layer the AR objects by type. In this way, the mobile terminal 10 according to the present embodiment can divide the AR objects into a greater variety of layers.

Although the present invention has been described by way of an embodiment with reference to the accompanying drawings, it is to be noted that various changes and modifications will be apparent to those skilled in the art. Therefore, such changes and modifications are to be understood as included within the scope of the present invention. For example, the functions and the like included in the various components may be reordered in any logically consistent way. Furthermore, components may be combined into one or divided.

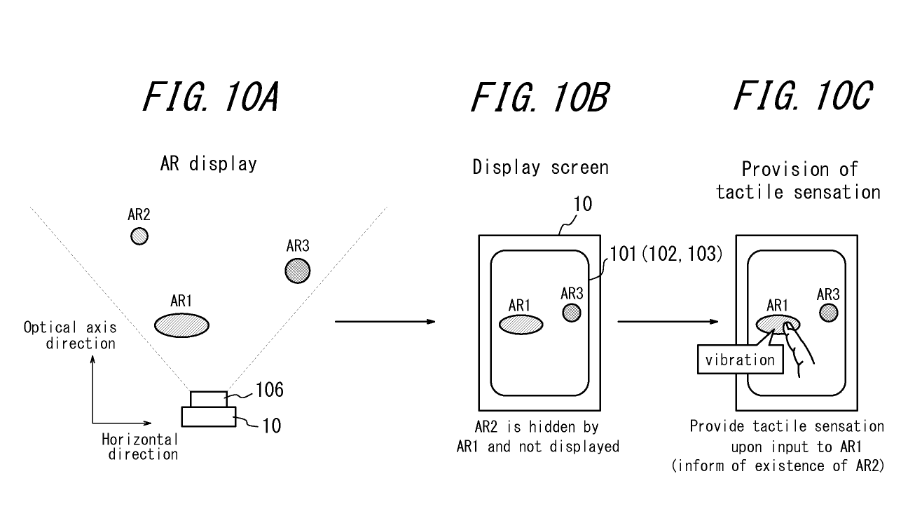

For example, when an AR object at the back is hidden by an AR object at the front, then upon detection of input to the AR object at the front, the control unit 110 can control the tactile sensation providing unit 104 so as to provide a tactile sensation for the input. FIG. 10 illustrates an example of providing a tactile sensation to a hidden AR object. As illustrated in FIG. 10A, there are three AR objects (AR1 to AR3) in the image, and as illustrated in FIG. 10B, AR2 at the back is hidden by AR1 at the front. In this case, when input to AR1 is detected, the control unit 110 can inform the user of the existence of AR2 by providing a tactile sensation for the input.

When an AR object is included in the image acquired by the imaging unit 106, the storage unit 109 can store the acquired image together with information on the AR object. In this way, the user can at any time confirm the AR objects related to images acquired in the past, thereby improving user-friendliness. The JPEG comment field, for example, may be used to store an AR object related to an acquired image.

In addition to pressure load or input, the control unit 110 can also use the number of inputs as a condition for switching the AR object display layer. Specifically, the control unit 110 can set conditions for switching so as to display any AR objects in the first layer upon the first input and any AR objects in the second layer upon the second input.

In regard to switching of the AR object display layer, the control unit 110 can also initialize the display layer so as to display the AR object furthest at the front in cases such as when no AR object for display remains or when switching of the display layer has completed a full cycle. In this way, the user can switch the display layer again after initialization, thereby improving user-friendliness.

Furthermore, the display unit 102 and the touch sensor 103 of the present embodiment may be constituted as an integrated device by, for example, providing a common substrate with both functions. An example of a device thus integrating the functions of both the display unit 102 and the touch sensor 103 is a liquid crystal panel having a matrix of pixel electrodes, with a plurality of photoelectric conversion elements, such as photodiodes, regularly mixed therein. This device is contacted by a pen at a desired position on the panel display, and while displaying images with the liquid crystal panel structure, the device can detect the contact position by light from a backlight for liquid crystal display being reflected by the tip of the pen and received by surrounding photoelectric conversion elements.

The control unit 110 according to the above embodiment switches the display layer when the pressure load detected by the load detection unit 105 satisfies a predetermined standard. Stating that the pressure load detected by the load detection unit 105 satisfies a predetermined standard may refer to the pressure load detected by the load detection unit 105 having reached a predetermined value or to the pressure load detected by the load detection unit 105 having exceeded a predetermined value, or may refer to the load detection unit 105 having detected a predetermined value. Furthermore, the control unit 110 may switch the display layer when data output by the load detection unit 105 upon detection of the pressure load satisfies a predetermined standard. The data output by the load detection unit may be electric power.

In the above explanation, the technical meaning of expressions such as, for example, a predetermined value “or more” and a predetermined value “or less” is not necessarily precise. In accordance with the specifications of the mobile terminal, these expressions encompass the cases both of including and of not including the value representing the standard. For example, a predetermined value “or more” may refer not only to the case of an increasing value reaching the predetermined value, but also the case of exceeding the predetermined value. Furthermore, a predetermined value “or less”, for example, may refer not only to the case of a decreasing value reaching the predetermined value, but also the case of falling below the predetermined value, i.e. of being less than the predetermined value.

### REFERENCE SIGNS LIST

10: Mobile terminal
101: Touch panel
102: Display unit
103: Touch sensor
104: Tactile sensation providing unit
105: Load detection unit
106: Imaging unit
107: Position information acquisition unit
108: Communications unit
109: Storage unit
110: Control unit

1. A mobile terminal comprising:
a touch sensor configured to detect input;
an imaging unit configured to acquire an image;
a display unit configured to display the image; and
a control unit configured to control the display unit to display virtual information included in the image by overlaying the virtual information on the image and configured to layer the virtual information and switch a display layer of the virtual information in accordance with the input.

2. The mobile terminal of claim 1, further comprising a position information acquisition unit configured to acquire position information, wherein
the control unit displays the virtual information by overlaying the virtual information on the image based on the position information.

3. The mobile terminal of claim 1, wherein the control unit displays the virtual information associated with an object included in the image by overlaying the virtual information on the image.

4. The mobile terminal of claim 1, further comprising a load detection unit configured to detect a pressure load of the input, wherein
the control unit switches the display layer of the virtual information in accordance with the pressure load.

5. The mobile terminal of claim 1, wherein the control unit switches the display layer of the virtual information when the input is detected at a position where pieces of the virtual information are in overlap.

6. The mobile terminal of claim 1, wherein the control unit only switches the display layer related to virtual information displayed at a position of the input.

7. The mobile terminal of claim 1, wherein the control unit performs the layering in accordance with a type of the virtual information.

8. The mobile terminal of claim 1, further comprising a tactile sensation providing unit configured to provide a tactile sensation to a touch face of the touch sensor, wherein
when virtual information at a back is hidden by virtual information at a front, the control unit controls the tactile sensation providing unit to provide a tactile sensation for the input upon the input being detected for the virtual information at the front.

9. A control method for a mobile terminal, the mobile terminal comprising:
a touch sensor configured to detect input;
an imaging unit configured to acquire an image; and
a display unit configured to display the image,
the control method comprising the steps of:
controlling the display unit to display virtual information included in the image by overlaying the virtual information on the image;
layering the virtual information; and
switching a display layer of the virtual information in accordance with the input.

10. The mobile terminal of claim 1, wherein, when a plurality of the virtual information are displayed, the control unit layers the plurality of the virtual information in accordance with overlapping of more than two virtual information among the plurality of the virtual information.

11. The mobile terminal of claim 1, wherein, when a first and a second virtual information are displayed overlaid on the image, and when the first virtual information is hidden behind the second virtual information, the control unit layers the first and the second virtual information in different layers.
